(19) United States
(12) Patent Application Publication
(10) Pub. No.: US 2023/0150881 A1
(43) Pub. Date: May 18, 2023

(54) A PROCESS FOR MAKING A SINTERED ARTICLE

(71) Applicant: Tipco BV, The Hague (NL)

(72) Inventors: Erik Severin, Kowloon (HK); John Vincent Adap Misa, Kowloon (HK); Erwin N. Fernandez, Kowloon (HK); Sandor Koszo, Kowloon (HK); Bo Wei Ma, Kowloon (HK)

(73) Assignee: Tipco BV, The Hague (NL)

(21) Appl. No.: 17/920,472

(22) PCT Filed: Apr. 23, 2021
(86) PCT No.: PCT/EP2021/060653

§ 371 Date: Oct. 21, 2022

(30) Foreign Application Priority Data
Apr. 23, 2020 (GB) 2005976.2

(51) Int. Cl. C04B 33/24; C04B 33/04; C04B 33/13; C04B 33/32; C04B 33/30

(52) U.S. Cl. CPC C04B 33/24; C04B 33/04; C04B 33/1315; C04B 33/323; C04B 33/30; C04B 2235/349; C04B 2235/3463; C04B 2235/5436; C04B 2235/604; C04B 2235/661

(57) ABSTRACT

A process for making a sintered article including the steps of: (a) preparing a particulate mixture; (b) contacting the particulate mixture to water to form a humidified mixture; (c) pressing the humidified mixture to form a green article; (d) optionally, subjecting the green article to an initial drying step; (e) subjecting the green article to a firing step in a kiln to form a hot fused article; and (f) cooling the hot fused article to form a sintered article. The particulate mixture includes: (i) at least 20 wt % coarse coal combustion fly ash; and (ii) at least 30 wt % clay, wherein the coarse coal combustion fly ash has a particle size in the range of from greater than 150 μm to less than 250 μm.

### FIELD OF THE INVENTION

The present invention relates to a process for making a sintered article. The resultant sintered articles have an appearance and texture similar to natural stone, such as sandstone, and typically have a rough surface, such as a rougher surface than unglazed porcelain tiles. The resultant sintered articles have low water absorption, are strong, and are suitable for use as floor and wall tiles, especially floor tiles having a sandstone-like appearance and texture.

### BACKGROUND OF THE INVENTION

There are major environmental and economic benefits in using coal combustion fly ash, which is amongst the most abundant waste material on earth, as a raw material in as many products as possible. The present invention describes a process for making a sintered article comprising coarse coal combustion fly ash. The sintered article has the appearance and texture of natural stone, including sandstone.

Much coal combustion fly ash is currently used in concrete as a pozzolan. In pozzolan applications, it is necessary to use the finest coal combustion fly ash as this maximises the available surface area for chemical reactions. In some applications, fine coal combustion fly ash is typically used because the smaller particle sizes have more contact with other particles and ingredients and can sinter and form new mineral phases at lower temperatures, typically giving stronger and more water-resistant articles.

This leaves an issue with what to do with the coarse coal combustion fly ash, for example the fly ash greater than 125 μm. This coarse material is much too large to be of interest or value to the cement industry, which typically just classifies off the finest fraction and leaves the rest. There is little reason for the cement industry to go to the effort of milling the coarse coal combustion fly ash to the required size since there is so much coal combustion fly ash available that simply classifying off the finest coal combustion fly ash is sufficient. Likewise, there is little reason for the industry to mill the coarsest coal combustion fly ash since this would take excessive time and there is plenty of finer coal combustion fly ash available.

The coarsest fractions of coal combustion fly ash (typically from greater than 125 μm to less than 250 μm) are too large to be of interest to the cement industry and too fine to be useful as an aggregate in concrete. This coarse material is currently just dumped in landfill. Applications that use this material offer particular environmental benefits.

There is a benefit in maximising the usage of coal combustion fly ash in sintered articles, and there is a greater benefit in being able to use the least valuable fraction of the coal combustion fly ash, which is the coarse fraction.

Sintered articles, such as sintered tiles, are one type of product that can use coal combustion fly ash as a raw material to replace conventional materials such as clay. There are many types of sintered tiles, for example wall tiles and porcelainized floor tiles, which can have a range of properties. Sintered tiles used for flooring require strength, wear resistance and (often) low water absorption. Porcelain tiles are often used for flooring due to their strength and resistance to water.

Sintered articles, such as sintered tiles, need to have a range of aesthetic characteristics given the range of consumer preferences. One such consumer preference is for sintered tiles that have the appearance and texture of natural stone, such as sandstone.

Another desirable requirement for a sintered floor tile is that it should be anti-slip. The roughness of the sintered floor tile surface has an important role in its anti-slip properties. The rougher the surface, the greater the friction and the less the likelihood of slipping.

The present invention provides a process for making a sintered article. The resultant sintered articles have an appearance and texture like natural stone. The process of the present invention uses coarse coal combustion fly ash material. Without wishing to be bound by theory, the inventors believe that roughness of the sintered article surface arises predominantly from the presence this coarse coal combustion fly ash material. During the process, the clay material shrinks during the firing stage, and the coarse coal combustion particles are raised above the surface of the sintered article. The resultant sintered articles have good anti-slip properties and have an appearance and texture similar to natural stone, such as sandstone.

### SUMMARY OF THE INVENTION

The present invention relates to a process for making a sintered article, the process comprises the steps of: (a) preparing a particulate mixture; (b) contacting the particulate mixture to water to form a humidified mixture; (c) pressing the humidified mixture to form a green article; (d) optionally, subjecting the green article to an initial drying step; (e) subjecting the green article to a firing step in a kiln to form a hot fused article; and (f) cooling the hot fused article to form a sintered article, wherein the particulate mixture comprises: (i) at least 20 wt % coarse coal combustion fly ash; and (ii) at least 30 wt % clay, wherein the coarse coal combustion fly ash has a particle size in the range of from greater than 150 μm to less than 250 μm.

### DETAILED DESCRIPTION OF THE INVENTION

Process for making a sintered article. The process for making a sintered article, the process comprises the steps of: (a) preparing a particulate mixture; (b) contacting the particulate mixture to water to form a humidified mixture; (c) pressing the humidified mixture to form a green article; (d) optionally, subjecting the green article to an initial drying step; (e) subjecting the green article to a firing step in a kiln to form a hot fused article; and (f) cooling the hot fused article to form a sintered article, wherein the particulate mixture comprises:(i) at least 20 wt % coarse coal combustion fly ash; (ii) at least 30 wt % clay; and (iii) optionally other ingredients, such as ingredients selected from feldspar and/or glass, wherein the coarse coal combustion fly ash has a particle size in the range of from greater than 150 μm to less than 250 μm.

Step (a) preparing a particulate mixture. During step (a), a particulate mixture is prepared.

Step (b) forming a humidified mixture. During step (b), the particulate mixture is contacted to water to form a humidified mixture.

Step (c) forming a green article. During step (c), the humidified mixture is pressed to form a green article.

Optional step (d) initial drying step. During the optional step (d), the green article may be subjected to an initial drying step.

Step (e) forming a hot fused article. During step (e), the green article is subjected to a firing step in a kiln to form a hot fused article.

Step (f) cooling step. During step (f), the hot fused article is cooled to form a sintered article,

Particulate mixture. The particulate mixture comprises: (i) at least 20 wt % coarse coal combustion fly ash; and (ii) at least 30 wt % clay.

It may be preferred that the particulate mixture comprises at least 25 wt %, or at least 30 wt % coarse coal combustion fly ash. The particulate mixture may comprise from 20 wt % to 40 wt % coarse coal combustion fly ash.

It may be preferred for the particulate mixture to comprise fine coal combustion fly ash. The particulate mixture may comprise at least 20 wt %, or at least 30 wt % fine coal combustion fly ash. The particulate mixture may comprise from 20 wt % to 40 wt % fine coal combustion fly ash. The inclusion of fine coal combustion ash can contribute to higher sintered article strengths and water resistance and also enable the use of lower firing temperatures. It also increases the overall amount of coal combustion fly ash that can be used in the particulate mixture which has environmental benefits.

Typically, the particulate mixture has an aluminium oxide content of less than 30 wt %, or less than 20 wt % or even less than 10 wt %. Coal combustion fly ashes that have lower levels of aluminium oxide (A₂O₃) will typically sinter at lower temperatures.

The particulate mixture may comprise from 40 wt % to 60 wt % clay.

The particulate mixture may have an aluminium oxide content of less than 30 wt %.

The particulate mixture may comprise other ingredients. Suitable ingredients may be selected from feldspar and/or glass. Feldspar is typically present at levels of from 5 wt % to 30 wt % of the mixture.

Coarse coal combustion fly ash. The coarse coal combustion fly ash has a particle size in the range of from greater than 125 μm to less than 250 μm, or less than 220 μm, or less than 200 μm. The coarse coal combustion fly ash may have a particle size in the range of from greater than 125 μm to 177 μm. The coarse coal combustion fly ash can be obtained by air classification, sieving or any other suitable particle size classification means.

Fine coal combustion fly ash. The fine coal combustion fly ash has a particle size of 125 μm or less, preferably from 75 μm to 125 μm, and more preferably from 75 μm to 90 μm. The fine coal combustion fly ash can be obtained by air classification, sieving or any other suitable particle size classification means.

Clay. A suitable clay is a standard clay such as Ukrainian clay. A preferred clay is a combination of standard clay and high plasticity clay. The weight ratio of standard clay to high plasticity clay may in the range of from 2:1 to 5:1. A suitable clay is a high plasticity clay such as bentonite clay. Typically, a high plasticity clay has an Attterburg's plasticity index of greater than 25.0. Typically, a standard clay has an Atterburg's plasticity index of 25.0 or less.

Sintered article. The sintered article is obtained by the process of the invention.

Preferably, the sintered article is a tile, more preferably a floor tile. Preferably, the sintered article is a porcelain tile, most preferably a porcelain floor tile.

Preferably, the sintered article, has a water absorption of 3.0% or less, or even 2.0% or less, or 1.0% or less, or even 0.5% or less. This is especially preferred when the sintered article is a floor tile.

Preferably, the surface of the sintered article has a roughness such that: (i) the Ra value is greater than 5.0 μm, or greater than 6.0 μm, or greater than 7.0 μm, or greater than 8.0 μm, or greater than 10.0μm, or greater than 12 μm, or even greater than 14.0 μm; and (ii) optionally, the Rz value is less than 70 μm, or less than 60 μm, or less than 50 μm, or less than 40 μm. This is especially preferred when the sintered article is a floor tile.

The surface texture of a sintered article, such as a tile, is important for realism if the article is trying to simulate a product such as a natural stone tile. The surface texture is also important for the anti-slip behaviour of a floor tile. The rougher the surface, the greater the friction and the less the likelihood of slipping.

There are well-established parameters for measuring surface texture and roughness. The most common are Ra (the arithmetic mean deviation of the profile) and Rz (the maximum height of the profile). Rz measures the maximum dimensions of the peaks/troughs of the profile.

A smooth, but not polished, natural stone tile has a degree of uniform surface roughness whilst not being too rough to the touch. Natural stone tiles can have various different surface finishes ranging from rough-cut slabs for exterior use to highly polished finishes for some internal applications. Highly polished stone tiles, such as sandstone tiles, may not feel authentic. Very rough-cut natural stone tiles may be too rough for many internal uses where they may be touched. Smooth, but not polished, natural stone tiles are often used internally. A smooth natural stone, such as a sandstone, is characterised by a uniform roughness partly coming from the grains forming the stone.

Ra, which is a commonly used measure for surface roughness (based on profilometry) is an average. Hence similar Ra values can be obtained for a surface with (i) many small peaks/troughs or (ii) a surface with a fewer but larger peaks/troughs. This difference is better shown by the Rz values. The tactile perception is better for surfaces with multiple smaller peaks/troughs as compared to surfaces with fewer, but larger peaks/troughs. Such surfaces can feel rougher or scratchy to the touch. Such surfaces can be defined by specifying Ra and Rz limits.

The inventors have observed that the tactile perception of tiles such as smooth stone tiles is better when they have a Ra value which is large enough such that the surface feels like a uniform high quality natural stone but the Rz value (which measures the largest peak/trough) is within an upper limit such that the surface does not feel unpleasantly rough or scratchy. Controlling the surface to have the desired Ra and Rz values keeps the surface uniformly rough enough to be convincing as a natural stone but to not feel unpleasantly rough or scratchy.

The optimum degree of surface roughness of a general use tile is therefore a balance of properties. If the levels of roughness are too low, the texture of the surface does not feel convincing. Also, tiles may not have sufficient anti-slip properties if they are too smooth. This is important for floor tiles. If roughness values are excessive, cleaning becomes harder and tactile perception can be negatively affected. In addition to practical considerations, flooring products such as sintered tiles should be aesthetically pleasing to view. The appearance and texture of natural stone, such as sandstone, is often highly regarded in this respect. Floor tiles also need to be strong and often water resistant and porcelainized tiles are preferred for these applications.

Preferably, the sintered article has a modulus of rupture of at least 35 MPa, or at least 40 MPa, or even at least 50 MPa. This is particularly beneficial when the article needs to be strong to resist cracking and the stresses, for example a floor tile when it is being walked on.

Method of measuring aluminium oxide content. The level of aluminium oxide is typically measured by X-ray fluorescence. The technique works by the excitation of the sample using high energy gamma or X-rays. This causes an ionisation of the atoms present which then emit characteristic frequency EM radiation which is dependent on the type of atom. Analysis of the intensity of different frequencies allows an elemental analysis to be made. Suitable equipment would be the Varta® range of XRF analyzers supplied by Olympus® and operated according to the manufacturer's instructions. The equipment detects elemental aluminium and the result is most usually converted to the corresponding level of Al₂O₃.

Method of measuring Ra and Rz surface roughness. Suitable equipment for this test is the Surtronic® range of Roughness Testers from Taylor Hobson® including the Duo and S-series. This equipment can measure roughness parameters according to ASTM 4287 including Rz (maximum height of the profile) and Ra (the arithmetic mean deviation of the profile). The equipment uses a very fine stylus and the probe is moved across the surface by simply drawing the probe along the length of the surface being tested. Typically, five or so different measurements are taken across the surface so as to get a broader average and ensure all surfaces are measured. The equipment can automatically calculate the various surface roughness measurements including Ra and Rz when correctly following the manufacturer's instructions.

Method of measuring water absorption. A sample of the sintered article to be measured is heated to a constant weight at 100° C. to ensure the sample is dry. The weight of the sample is then measured (original sample weight). The dry sintered article is then immersed in boiling water (taking care that the sample does not contact any heating surfaces). The sample is then allowed to cool in the water for 12 hours making sure that no surface is exposed to air during this time. The sample is then taken from the water and touch dried with a dampened cloth to remove surface droplets. The sample is then weighed (absorbed weight). The amount of absorbed water in the sample is the difference of these two weights (absorbed sample weight−original sample weight=weight of absorbed water). The wt % water absorption is calculated by dividing the weight of absorbed water by the original sample weight and multiplying the result by 100.

Method of measuring the modulus of rupture (MOR). The MOR of a sample can be measured by testing a sample according to ASTM C1505-15. The sintered article being tested is placed resting on two parallel, cylindrical support rods such that the edges of the tile are parallel to the axis of the rods. The span between the rods is a defined distance L and the edges of the tile need to overhang the support rods. The test article has a width b (in mm) and a thickness h (in mm). A third rod is placed across the middle of the test article and parallel to the others. An increasing load is applied to the middle rod until the test article ruptures or breaks at the breaking load P (in N). This can be used to calculate B, the breaking strength, using the equation B=(P×L)/b. The modulus of rupture (MOR) is then given by the equation MOR=3B/2h².

### EXAMPLES

A mixture is prepared as follows:

200 grams of clay is milled in a ball mill (MITR, model YXQM-8L) having a container of 152 mm and depth of 172 mm. The container has approx 1250 g of alumina grinding balls added to it. The alumina balls (density 3.95 g/ml) have the following size distribution: 5 mm (50% wt), 10 mm (32% wt), 20 mm (18% wt). The clay is then milled at 180 rpm for 60 min.
Next, coal combustion fly ash is sieved using a 250 μm sieve and a 125 μm sieve so as to collect the fraction>125 μm and <250 μm.

Following this, 100 g of the milled clay is mixed with 100 g of the sieved fly ash. Then 16 g of water are sprayed on to 200 g of the mix as a binder. The wetted powder mix is then shaken through the 500 μm mesh and granulated prior to pressing.

140 g of the mix is then uniaxially pressed in a rectangular mild steel mold (155×40 mm) to a pressure of 40 MPa which is held for 1.5 min (90 sec). The formed body is released from the mold and placed into a 110° C. oven to dry (for 2 hrs).
The dried body is fired in an electric kiln at a ramp rate of 2.5° C./min to 1400° C. The temperature is held at the top temperature for 30 min. The fired body is then allowed to cool down naturally (hence slowly) to room temperature.
The fired sintered article has the appearance and colour of sandstone. The average Ra is 8 μm, the Rz is less than 50 μm and the water absorption is less than 3%.

1. A process for making a sintered article, the process comprises the steps of:
(a) preparing a particulate mixture;
(b) contacting the particulate mixture to water to form a humidified mixture;
(c) pressing the humidified mixture to form a green article;
(d) optionally, subjecting the green article to an initial drying step;
(e) subjecting the green article to a firing step in a kiln to form a hot fused article; and
(f) cooling the hot fused article to form a sintered article,
wherein the particulate mixture comprises:
(i) at least 20 wt % coarse coal combustion fly ash; and
(ii) at least 30 wt % clay,
wherein the coarse coal combustion fly ash has a particle size in the range of from greater than 125 μm to less than 250 μm.

2. A process according to claim 1, wherein coarse coal combustion fly ash has a particle size in the range of from greater than 125 μm to 177 μm.

3. A process according to claim 1, wherein the particulate mixture comprises at least 20 wt % fine coal combustion fly ash, wherein the fine coal combustion fly ash has a particle size of 125 μm or less.

4. A process according to claim 3, wherein the fine coal combustion fly ash has a particle size in the range of from greater than 75 μm to 125 μm.

5. A process according to claim 1, wherein the particulate mixture comprises from 20 wt % to 40 wt % coarse coal combustion fly ash.

6. A process according to claim 1, wherein the particulate mixture comprises from 20 wt % to 40 wt % fine coal combustion fly ash.

7. A process according to claim 1, wherein the particulate mixture comprises from 40 wt % to 60 wt % clay.

8. A process according to claim 1, wherein the particulate mixture has an aluminium oxide content of less than 30 wt %.

9. A sintered article obtained by a process according to claim 1.

10. A sintered article according to claim 9, wherein the sintered article is a tile.

11. A sintered article according to claim 9, wherein the sintered article has a water absorption of 3.0 wt % or less.

12. A sintered article according to claim 9, wherein a surface of the sintered article has a roughness such that:
(i) an Ra value is greater than 5.0 μm; and
(ii) an Rz value is less than 70 μm.

13. A sintered article according to claim 9, wherein the sintered article has a modulus of rupture of at least 35 MPa.

14. A sintered article according to claim 10, wherein the sintered article is a porcelain tile.
